(19) United States
(12) Patent Application Publication
(10) Pub. No.: US 2009/0245423 A1
(43) Pub. Date: Oct. 1, 2009

(54) De-Interlever That Simultaneously Generates Multiple Reorder Indices

(75) Inventors: Ali RostamPisheh, San Diego, CA (US); Raghu Challa, San Diego, CA (US); Ravi Palanki, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/333,131

(22) Filed: Dec. 11, 2008

Related U.S. Application Data
(60) Provisional application No. 61/040,549, filed on Mar. 28, 2008.
(60) Provisional application No. 61/041,296, filed on Apr. 1, 2008.

(51) Int. Cl. H04L 27/00; G06F 12/00

(52) U.S. Cl. 375/316; 711/157; 711/217

(57) ABSTRACT

A de-interleaver involves logic that receives a seed and that simultaneously generates from the seed a plurality of reorder indices. The plurality of reorder indices is usable for de-interleaving an incoming stream of interleaved code bits. Each plurality of simultaneously generated reorder indices generated corresponds to a set of simultaneously received code bits in the incoming stream. The reorder indices are converted into physical addresses in parallel and these physical addresses are used to store the set of code bits into a memory. Code bits for multiple sub-packets of different sub-packet sizes are typically present in memory at the same time. The code bits are then read out of memory to form an outgoing stream of de-interleaved code bits. The de-interleaver has a pipelined architecture such that sets of code bits are written into the memory at the same rate that sets of code bits are received onto the de-interleaver.

### CROSS-REFERENCE TO RELATED APPLICATIONS

This application claims the benefit under 35 U.S.C. §119 of Provisional Application Ser. No. 61/040,549, filed Mar. 28, 2008, and of Provisional Application Ser. No. 61,041,296, filed Apr. 1, 2008, said two provisional applications are both incorporated herein by reference.

### BACKGROUND INFORMATION

1. Technical Field

The disclosed embodiments relate to de-interleaving, and more particularly to de-interleaving in accordance with a Pruned Bit-Reversal Interleaved (PBRI) method.

2. Background Information

In a communication system, a transmitter typically encodes a packet (also referred to as a sub-packet) of traffic data to generate a sub-packet of code bits, interleaves (reorders) the code bits of the sub-packet, and modulates the interleaved bits to generate modulation symbols. The transmitter then processes and transmits the modulation symbols via a communication channel. The data transmission may be degraded by impairments in the communication channel, such as thermal noise, interference, spurious signals, and so on. A receiver obtains a distorted version of the transmitted modulation symbols and reverses the processes of the transmitter in order to regenerate the original traffic data.

Encoding and interleaving allow the receiver to recover the transmitted traffic data in the presence of degradations in the received symbols. The encoding may include error detection code that allows the receiver to detect errors in the received traffic data and/or error correction coding that allows the receiver to correct for errors in the received traffic data. Error correction coding may add redundancy to the coded information. This redundancy allows the receiver to recover the transmitted traffic data even if some errors are encountered during transmission. The interleaving reorders the code bits in the sub-packet so that code bits that would otherwise be near each other are separated in time, frequency, and/or space during transmission. If a burst of errors occurs during transmission, then the corrupted code bits are spread apart after the de-interleaving at the receiver, which improves decoding performance.

Published United States Patent Application 2006/0156199, by Palanki et al., discloses an interleaving method referred to as Pruned Bit-Reversal Interleaved (PBRI) interleaving. In one example of PBRI interleaving, a sub-packet of traffic data of a first size is received into an interleaver in the transmitter. The sub-packet is extended to a second size that is a power of two, for example by appending padding code bits. The code bits of the extended sub-packet are interleaved in accordance with a bit-reversal interleave scheme. The interleaved sub-packet of the extended second size is then pruned back down to the first size, for example, by removing the bit-reversed code bits for the appended padding. After transmission, a de-interleaver in the receiver receives the sub-packet of interleaved code bits, and reorders the code bits to regenerate the original sub-packet having code bits in their original order. The process of determining how to reorder the code bits in the de-interleaver is involved and may involve multiple sequential steps. Efficient and high-speed PBRI de-interleavers and de-interleaving methods are desired for use in receivers.

### SUMMARY

A de-interleaver (for example, in a radio receiver of a cellular telephone) involves an amount of non-sequential logic. The amount of non-sequential logic receives a seed and generates from the seed a plurality of reorder indices. The plurality of reorder indices is generated simultaneously in parallel. In one example, the reorder indices are generated simultaneously as a consequence of supplying the seed to the amount of non-sequential logic. The amount of non-sequential logic is used over and over to generate successive such pluralities of reorder indices by supplying the amount of non-sequential logic with an appropriately updated seed for each successive use.

Each plurality of reorder indices that is simultaneously generated in this way relates to a corresponding set of code bits in an incoming stream of interleaved code bits.

Each plurality of reorder indices is converted in parallel into a corresponding plurality of physical addresses. This plurality of physical addresses is used to store the corresponding set of code bits into a memory. Code bits for multiple sub-packets of different sub-packet sizes are typically present in the memory and are undergoing de-interleaving at the same time. The de-interleaver has a pipelined hardware architecture such that sets of code bits are written into the memory at the same rate that sets of code bits are received onto the de-interleaver. In one example, a first processing step of simultaneously generating pluralities of reorder indices, a second processing step of using a plurality of reorder indices to generate a corresponding plurality of physical addresses, and a third processing step of using the plurality of physical addresses to store a set of code bits into the memory are pipelined. Each of these processing steps occurs in one period of a clock signal that clocks the de-interleaver.

Once the code bits of a sub-packet are stored in the memory, the code bits are read out of the memory at the appropriate time and in the appropriate way such that an outgoing stream of de-interleaved code bits is formed. In one example, the de-interleaver outputs an interrupt signal once all the code bits for a sub-packet are stored into the memory. In response to the interrupt signal, the memory is read in a linearly-addressed fashion, thereby reading the code bits of the sub-packet out of the memory and thereby forming the outgoing stream of de-interleaved code bits.

In another novel aspect, a shift and threshold adjust method allows relatively simple bit-reverse hardware to be employed to de-interleave sub-packets of different sub-packet sizes. For example, during PBRI reorder index generation for code bits of a sub-packet of a small size, a number of zero bits PBRI_SHIFT is added to the seed, thereby increasing the number of bits in the seed to match the width of hardware bit-reversers in a PBRI reorder index generator. The sub-packet size is shifted the same number of bit positions PBRI_SHIFT to form an ADJUSTED_THRESHOLD value. The seed, having the larger number of bits, is processed by a candidate generator and associated selection network. The bit-reversed values output by the candidate generator are compared to ADJUSTED_THRESHOLD to determine if they are out of range. The resulting selected bit reversed values as output from the selection network are then shifted back by the PBRI_SHIFT number of bit positions prior to physical address translation.

The foregoing is a summary and thus contains, by necessity, simplifications, generalizations and omissions of detail; consequently, those skilled in the art will appreciate that the summary is illustrative only and does not purport to be limiting in any way. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 is a simplified diagram of a mobile communication device.

FIG. 2 is a more detailed diagram of the RF transceiver integrated circuit of FIG. 1.

FIG. 3 is a more detailed diagram of the digital baseband integrated circuit of FIG. 1.

FIG. 4 is a block diagram that shows a novel de-interleaver circuit 41 that is a part of the demap sub-circuit 34 of FIG. 3.

FIG. 5 is a diagram that illustrates an example of an incoming stream of interleaved code bits that passes into the de-interleaver circuit 41 of FIG. 4. FIG. 5 also illustrates an example of an outgoing stream of de-interleaved code bits that passes out of the de-interleaver circuit 41 of FIG. 4.

FIGS. 6, 7 and 8 are diagrams that illustrate how PBRI reorder indices are determined for the example of the incoming code bit sequence of FIG. 5.

FIGS. 9-18 illustrate further details of an operation of generating of PBRI reorder indices for the incoming code bit sequence of FIG. 5.

FIG. 19 illustrates how bits in the most-significant bit column of bit-reversed values toggle between “1” and “0”.

FIG. 20 illustrates a circuit that receives a current seed value and generates therefrom two bit-reversed values.

FIG. 21 illustrates additional circuitry that is added to the circuitry of FIG. 20 to implement additional aspects of a novel method of generating PBRI reorder indices.

FIG. 22 is a schematic representation of selection that is made in the generation of a PBRI reorder index.

FIG. 23 illustrates a circuit which, for one input current seed value, simultaneously generates six PBRI reorder indices in parallel.

FIG. 24 is a block diagram of the de-interleaver circuit 41 of FIG. 4.

FIG. 25 is a diagram that illustrates further details of the memory system 87 of the de-interleaver circuit 41 of FIG. 24.

FIG. 26 is a more detailed diagram of the PBRI address generator 86 of the de-interleaver circuit 41.

FIG. 27 is a more detailed diagram of the candidate generator 97 of the PBRI reorder index generator 94 of FIG. 26.

FIG. 28 is a more detailed diagram of the selection network 98 of the PBRI reorder index generator 94 of FIG. 26.

FIG. 29 is a time line diagram that illustrates the pipelined operation of parts of the de-interleaver 41 of FIG. 24.

FIG. 30 is a flowchart of a method 200 in accordance with one novel aspect.

FIG. 31 is a diagram of a sub-packet of size 1024.

FIG. 32 is a diagram of a sub-packet of size 130.

FIG. 33 is a table that illustrates how PBRI reorder indices for the sub-packet of FIG. 32 can be represented in a 10-bit address field.

FIG. 34 illustrates how all the bit positions are reversed in a de-interleaving of a sub-packet of the size illustrated in FIG. 31.

FIG. 35 illustrates how some, but not all, of the bit positions are reversed in a de-interleaving of a sub-packet of the size illustrated in FIG. 32.

FIG. 36 is a diagram that illustrates an undesirable complexity associated with bit-reversing hardware capable of performing bit reversals on a variable number of bits.

FIG. 37 is a table that illustrates a novel shift and threshold adjust method whereby the complexities of FIG. 36 can be avoided.

### DETAILED DESCRIPTION

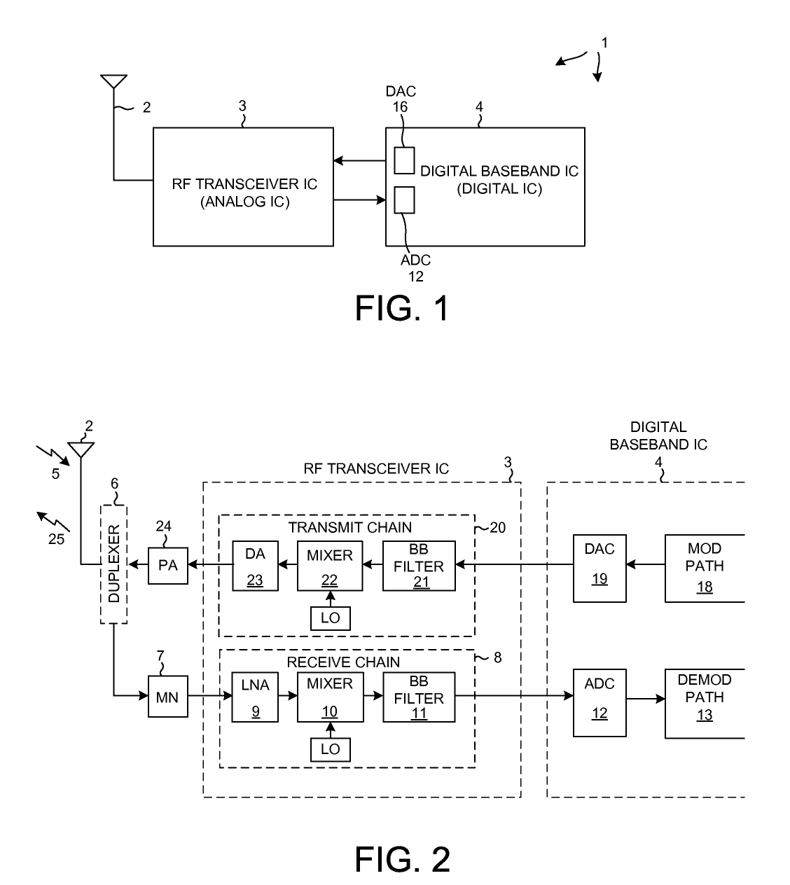

FIG. 1 is a very simplified high level block diagram of one particular type of mobile communication device 100 in accordance with one novel aspect. In this particular example, mobile communication device 1 is a cellular telephone. Mobile communication device 1 includes (among several other parts not illustrated) an antenna 2 and two integrated circuits 3 and 4. Integrated circuit 3 is an RF transceiver integrated circuit. RF transceiver integrated circuit 3 is called a “transceiver” because it includes a transmitter as well as a receiver. The term “transceiver”, however, also applies to the overall circuit of the mobile communication device 1 because aspects of the receiver and transmitter are disposed in integrated circuit 4 as well as in integrated circuit 3. RF transceiver integrated circuit 3 is principally an analog integrated circuit involving analog circuitry. Integrated circuit 4, on the other hand, is principally a digital integrated circuit that includes digital circuitry. Integrated circuit 4 is called a “digital baseband integrated circuit” or a “baseband processor integrated circuit”.

FIG. 2 is a more detailed block diagram of the RF transceiver integrated circuit 3. When cellular telephone 1 is receiving, a high frequency RF signal 5 is received on antenna 2. Information from signal 5 passes through duplexer 6, matching network 7, and through the receive chain 8. The signal is amplified by Low Noise Amplifier (LNA) 9 and is down-converted in frequency by mixer 10. The resulting down-converted signal is filtered by baseband filter 11 and is passed to the digital baseband integrated circuit 4. An Analog-to-Digital Converter (ADC) 12 in digital baseband integrated circuit 4 converts the signal into digital form and the resulting digital information is processed by a demodulator hardware path 13 within digital baseband integrated circuit 4.

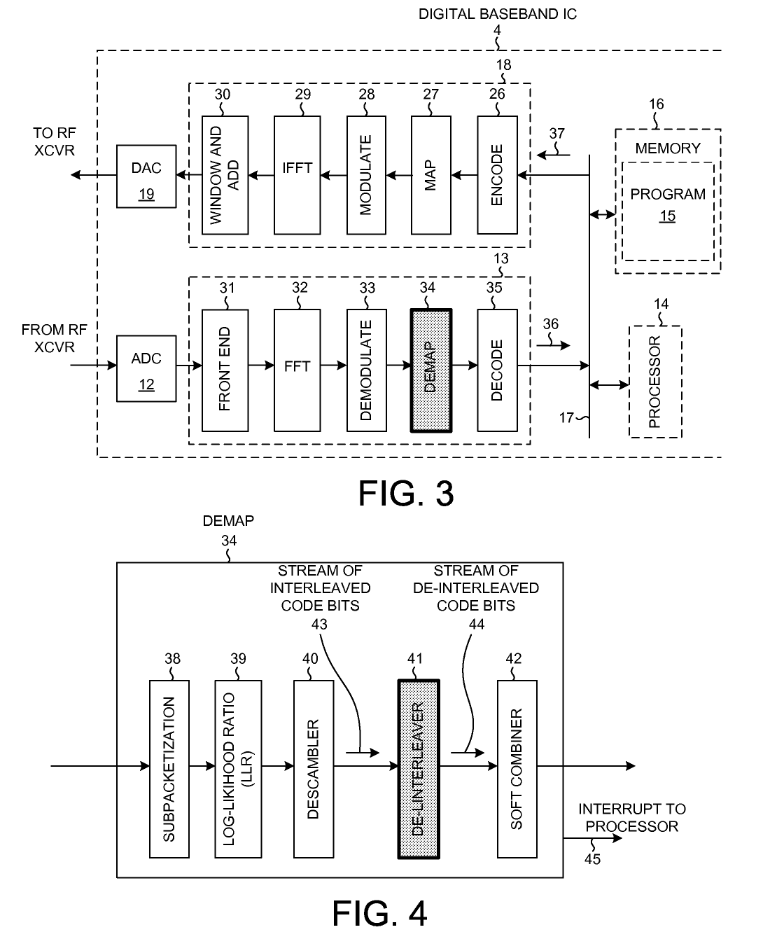

FIG. 3 is a more detailed diagram of a part of digital baseband integrated circuit 4. Demodulator hardware path 13 includes a front end circuit 31, a Fast Fourier Transform circuit 32, a demodulator circuit 33, a demap circuit 34, and a decoder circuit 35. After processing by demodulator hardware path 13, the received information 36 is further processed by processor 14. Processor 14 controls the overall mobile communication device 1. Processor 14 executes a program of processor-executable instructions 15 stored in a processor-readable medium 16. Processor-readable medium 16 in this case is a semiconductor memory. Processor 14 can access memory 16 across local bus 17.

If the cellular telephone is transmitting, then information 37 to be transmitted passes through a modulator hardware path 18 within digital baseband integrated circuit 4. As indicated in FIG. 3, modulator hardware path 18 includes an encoder circuit 26, a mapper circuit 27, a modulator circuit 28, an Inverse Fast Fourier Transform (IFFT) circuit 29, and a windowing circuit 30. The circuits 26-30 and 31-35 of the modulator and demodulator hardware paths are sometimes referred to as modem sub-circuits. The processed information as output from the modulator hardware path 18 is converted into analog form by a Digital-to-Analog Converter (DAC) 19. The resulting analog signal is supplied to “transmit chain” 20 of RF transceiver integrated circuit 3. Baseband filter 21 filters out noise introduced by the digital-to-analog conversion process. Mixer block 22 then up-converts the signal into a high frequency signal. Driver amplifier 23 and an external power amplifier 24 amplify the high frequency signal to drive antenna 2 so that a high frequency RF signal 25 is transmitted from antenna 2.

FIG. 4 is a more detailed circuit diagram of demap circuit 34 of FIG. 3. Demap circuit 34 includes a packetization circuit 38, a log-likelihood ratio (LLR) circuit 39, a descaler circuit 40, a de-interleaver circuit 41, and a soft combiner circuit 42. De-interleaver circuit 41 receives a stream of interleaved code bits 43, de-interleaves the stream, and outputs a de-interleaved stream 44 of code bits. The streams 43 and 44 include code bits for multiple sub-packets. Once all the code bits of a sub-packet have been processed by demap circuit 34, the demap circuit supplies an interrupt signal via conductor 45 to an interrupt controller (not shown) within processor 14. In response to this interrupt, processor 14 controls decode circuit 35 to read the sub-packet of code bits out of a memory in demap circuit 34 and to begin decoding the sub-packet.

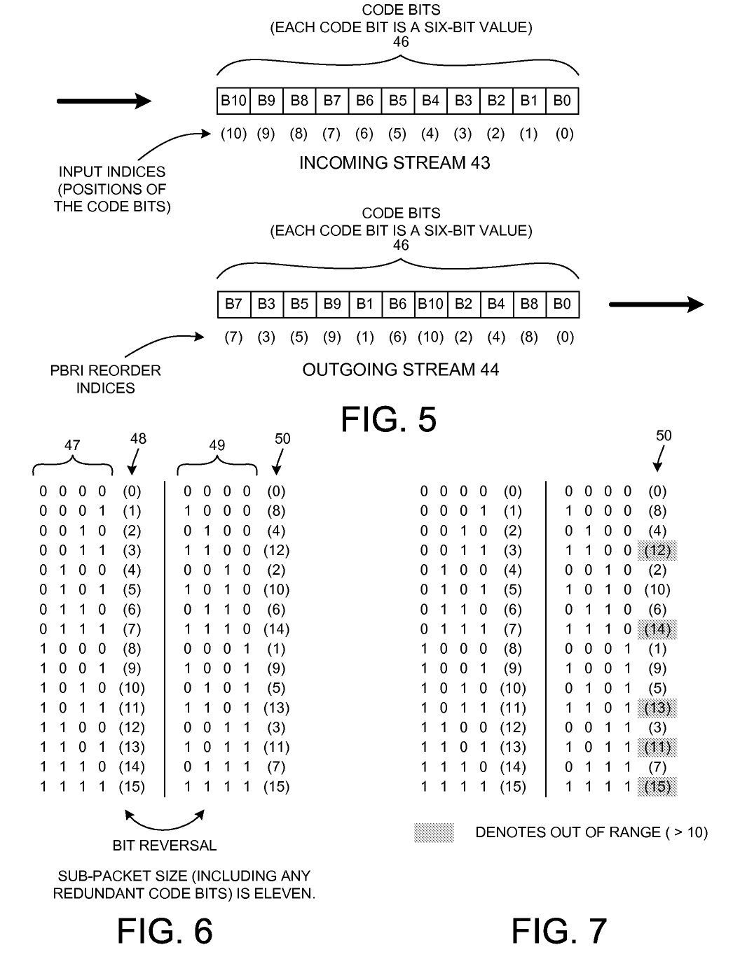

FIG. 5 is a diagram that illustrates an example of stream 43 of interleaved code bits received from descrambler 40. In the illustration of FIG. 5, time proceeds from left to right. Code bit B0 is received into de-interleaver circuit 41 first, followed by code bit B1, and so forth. Code bits B0-B10 in this example are all the code bits for a single sub-packet 46. Because sub-packet 46 has eleven code bits, the sub-packet is said to have a size of eleven. Each code bit has an associated input index. The input index of a code bit identifies its relative position to other code bits within interleaved sub-packet 46. In FIG. 5, the input index for a code bit is set forth in parentheses below the box representing the corresponding code bit in the incoming stream 43 of code bits. The code bits B0-B10 of sub-packet 46 are interleaved (shuffled) in accordance with a Pruned Bit-Reversal Interleaved (PBRI) method. For more information on a PBRI method, see: Published United States Patent Application 2006/0156199, by Palanki et al.

FIG. 5 also illustrates an example of outgoing stream 44 of code bits of sub-packet 46 after de-interleaving by de-interleaver circuit 41. As indicated by the indices, note that the positions of the code bits B0-B11 are de-interleaved (deshuffled). The indices defining the reordered and de-interleaved code bit positions are referred to here as “PBRI reorder indices”. To de-interleave a sub-packet of code bits, the indices for the various code bits in the de-interleaved packet are determined. For each successive PBRI reorder index in the sequence of PBRI reorder indices, the associated code bit is output to form the de-interleaved stream 44.

FIGS. 6-8 are diagrams that illustrate one way that the PBRI reorder indices may be determined for the example of FIG. 5. In the example of FIG. 5, the sub-packet has a size of eleven. The minimum number of binary bits that can represent eleven values is four. The sixteen possible 4-bit binary values are therefore set forth in the left most column 47 of FIG. 6. For each 4-bit value, its corresponding decimal representation is set forth in parentheses in the next left-most column 48. 4-bit binary value “0000” for example is represented by decimal value (0). The PBRI method involves a “bit reversal” operation. The bit reversed version of each 4-bit value in column 47 is therefore recorded in column 49. 4-bit binary value “0111” in column 47 for example is bit reversed to be 4-bit binary value “1110” in column 49. The rightmost column 50 sets forth the decimal equivalents of the values in column 49. The relationship between columns 48 and 49 defines a reordering, but there are more indices in these columns than there are code bits in packet 46. The size of sub-packet 46 is eleven, and there are sixteen value in columns 48 and 50. The number of reorder indices is therefore “pruned” down to eleven. As indicated in FIG. 7, values in the rightmost column that are greater than ten are said to be “out of range” and are indicated in FIG. 7 with darkened backgrounds.

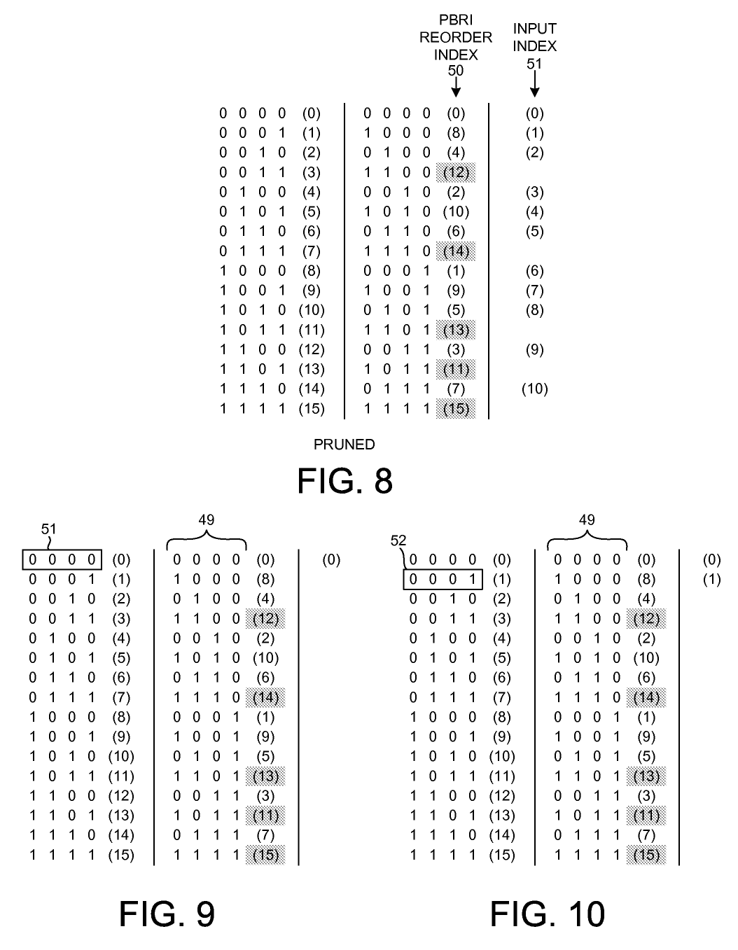

FIG. 8 illustrates a subsequent step. Another column 51 of decimal values is generated to the right of column 50. The values in column 51 will be the starting “input indices” (see FIG. 5) of code bits. Time, in the diagram of FIG. 8, extends from top to bottom. Accordingly, the first input index is (0). This first input index (0) is assigned the first PBRI reorder index in column 50, the value (0). The second input index (1) is assigned the second PBRI reorder index in column 50, (8). The third input index (2) is assigned the third PBRI reorder index (4). The fourth input index (3) is assigned the fourth “in range” PBRI reorder index (2) in column 50. Reorder index (12) is not assigned because its value is greater than (10), and is therefore out of range. The next input index (4) is assigned the next “in range” PBRI reorder index (10). This process of assigning PBRI reorder indices to successive input indices continues to generate the input index to PBRI reorder index relationship set forth in FIG. 8. Because reorder indices (11) through (15) are not used, the number of reorder indices is said to have been “pruned”. Referring back to FIG. 5, note that the sequence of code bit positions in the de-interleaved stream is (0), (8), (4), (2), (10), (6), (1), (9), (5), (3) and (7). This is the same sequence set forth in column 50 of FIG. 8.

FIGS. 9-18 illustrate further details of an operation of generating of the PBRI reorder indices for the incoming code bit sequence of FIG. 5. When the first code bit B0 is received, an initial “seed value” of “0000” used. The box 51 identifies this initial “seed value”. The initial seed value is bit reversed to generate the value “0000” that appears as first row value “0000” in column 49. Because the bit-reversed version of the seed is within range, the decimal equivalent (0) of the bit-reversed value is used as the “PBRI reorder index” for the input index of (0).

Next, processing proceeds to the second code bit B1 of the input stream. This code bit is assigned the next input index value of (1) as indicated in FIG. 10. The prior seed value of “0000” is incremented by one to become the current seed. Box 52 identifies the current seed. As in the case of FIG. 9, the current seed value of “0001” is bit reversed. The bit reversed version is the value “1000” in the second row of column 49. Because the bit-reversed version of the seed is within range, the decimal equivalent (8) of the bit-reversed value is used as the “PBRI reorder index” for the input index of (1).

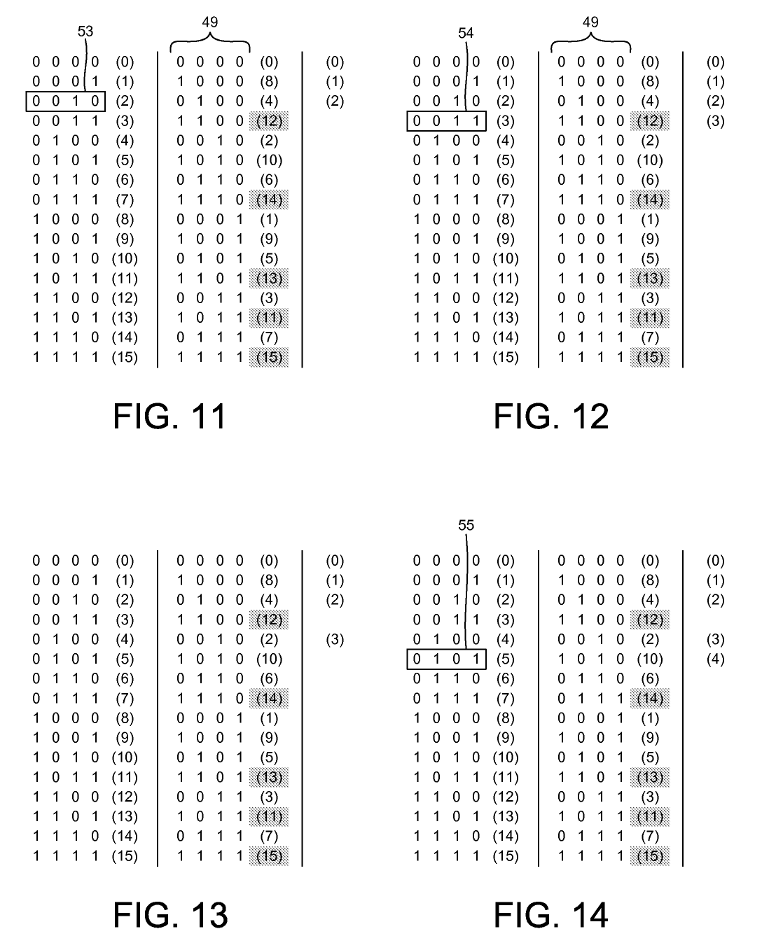

FIG. 11 illustrates the generation of the PBRI reorder index for the third code bit B2 of the input stream. Again, the prior seed value of “0001” is incremented to generate the current seed value of “0010”. The current seed is identified by box 53. The current seed value “0010” is bit-reversed to generate the value “0100” in the third row of column 49. Because the bit-reversed version of the seed is within range, the decimal equivalent (2) of the bit-reversed value is used as the “PBRI reorder index” for the input index of (2).

FIG. 12 illustrates the generation of the PBRI reorder index for the fourth code bit B3 of the input stream. Again, the prior seed value of “0010” is incremented to generate the current seed value of “0011”. The current seed is identified by box 54. The current seed value “0011” is bit-reversed to generate the value “1100” in the fourth row of column 49. The bit-reversed version of the seed is, in the case of FIG. 12, not within range. The decimal equivalent of the bit-reversed version of the seed is (12), but this value is greater than (10) and is therefore out of range. This value is not, therefore, used as the PBRI reorder index. In accordance with the pruned methodology set forth in FIG. 8 as described above, the seed value is incremented by one (“0100”) to become the new seed, and this value is bit-reversed, and the bit-reversed value “0010” is within range. Accordingly, the fourth input code bit index (3) is assigned PBRI reorder index (2) as indicated in FIG. 13. Note that although the bit-reversed version of the seed was out of range, the bit-reversed version of the seed incremented by one was in range.

FIG. 14 illustrates the generation of the PBRI reorder index for the fifth code bit B4 of the input stream. Again, the prior seed value of “0100” is incremented to generate the current seed value of “0101” identified by box 55. The current seed value “0101” is bit-reversed to generate the value “1010” in the sixth row of column 49. Because the bit-reversed version of the seed is within range, the decimal equivalent (10) of the bit-reversed value is used as the “PBRI reorder index” for the input index of (4).

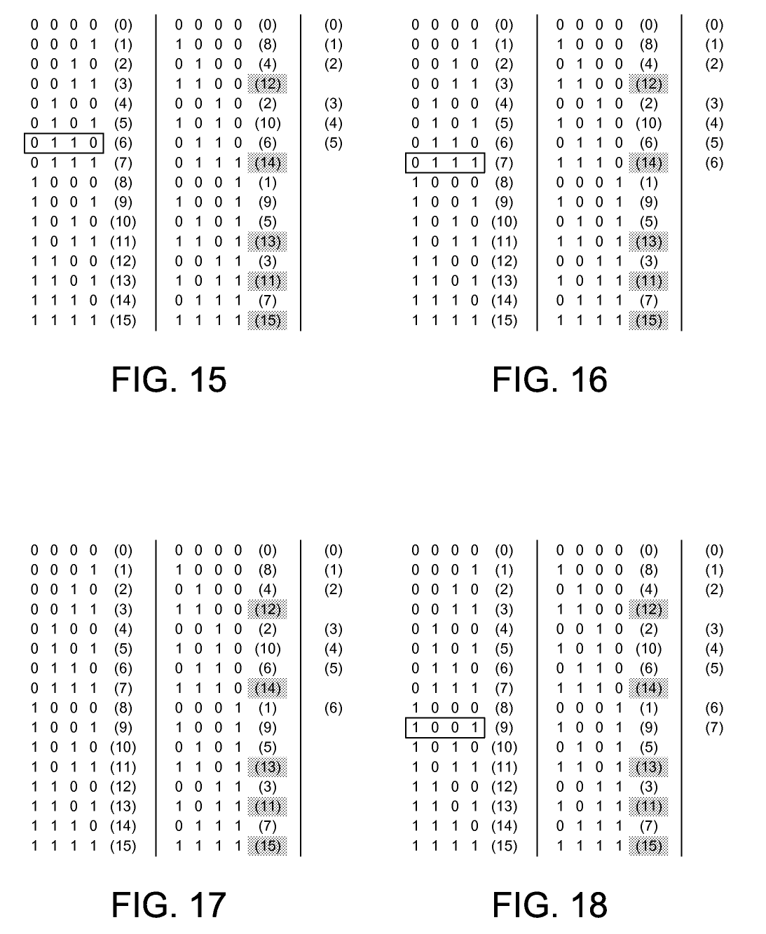

This process of incrementing the seed to generate a current seed, and of bit-reversing the current seed, and of determining whether the bit-reversed value is in range is repeated as indicated in FIGS. 15-18. If the bit reversed value is not in range, then the current seed is incremented, and this value is bit-reversed, and the resulting value is in range and is used at the PBRI reorder index. It is a property of the bit-reversal scheme that if a bit-reversed version of the current seed is determined to be out of range, that the bit-reversed value of the incremented version of the current seed will be in range.

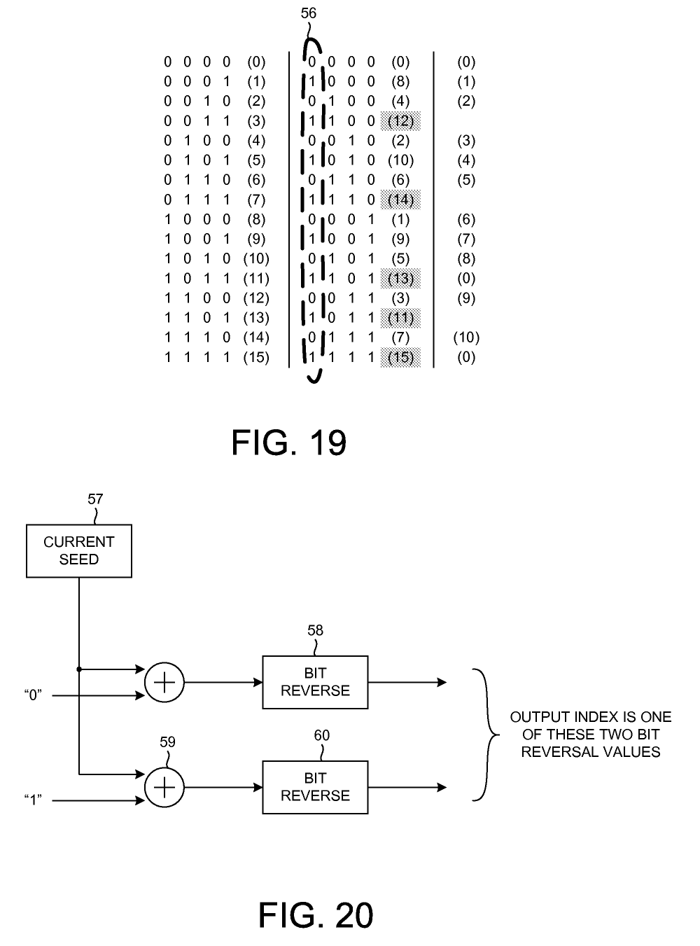

FIG. 19 illustrates how bits in the most-significant bit column 56 toggle between “1” and “0” extending vertically through the table of FIG. 19. Accordingly, if the bit reversed version of the current seed is out of range due to the most significant bit of the bit reversed value being greater than ten, then the next bit-reversed value down in the table will have a most significant bit of “0”. The bit-reversed value of the incremented current seed is therefore guaranteed to be in range. In one novel aspect, this property is recognized and is put to use in a hardware circuit.

FIG. 20 illustrates a circuit that receives a current seed value from source 57. The unincremented version of this current seed value is supplied to a bit-reversal circuit 58. An incremented version of the current seed is generated by adder 59 that adds a binary “1” to the current seed value and supplies the incremented version of the current seed to bit-reversal circuit 60. For a given current seed value in the processing described above in connection with FIGS. 9-18, if the bit-reversed value output by bit-reversal circuit 58 is out of range, then the bit-reversed value output by bit-reversal circuit 60 will be in range.

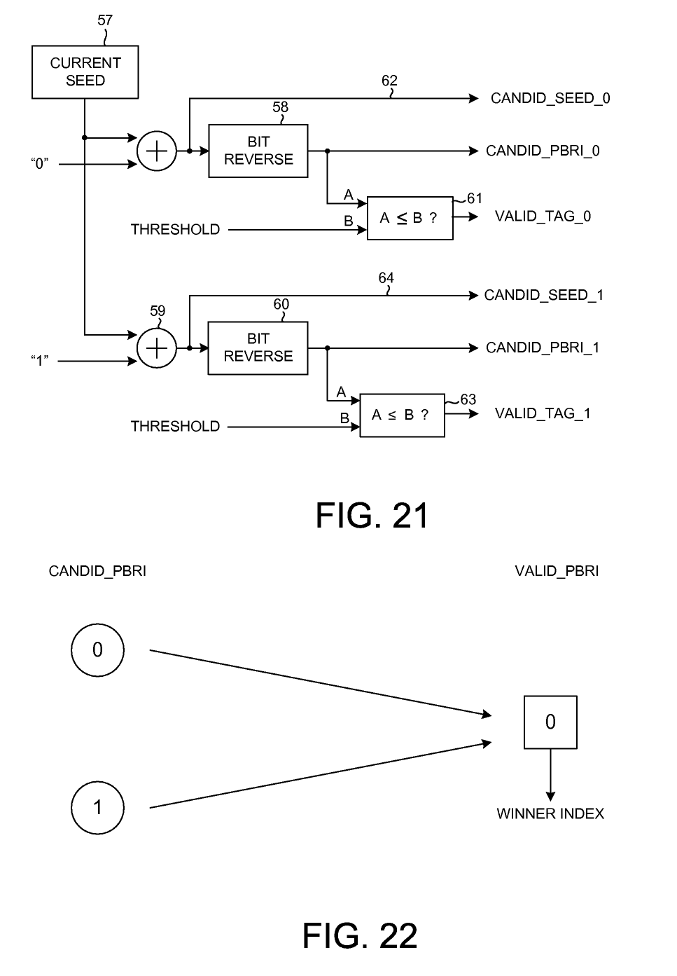

FIG. 21 illustrates additional circuitry that is added to the circuitry of FIG. 20 to implement additional aspects of the method of generating PBRI reorder indices described above. The added circuitry makes a determination as to whether a bit-reversed value is out of range. A comparator 61 compares the bit-reversed value output by bit-reversal circuit 58 to an adjusted threshold, thereby outputting an indication of whether the bit-reversed version of the current seed is out of range. If the bit reversed output of bit-reversal circuit 58 is used at the PBRI reorder index, then the next current seed will be the incremented version of the value that was bit reversed. Conductors 62 therefore output the value that should be incremented by one to generate the next current seed if the output of bit-reversal circuit 58 outputs an in range value.

Similarly, a comparator 63 compares the bit-reversed value output by bit-reversal circuit 60 to the adjusted threshold, thereby outputting an indication of whether the bit-reversed version of the current seed incremented by one is out of range. If the bit reversed output of bit-reversal circuit 60 is used at the PBRI reorder index, then the next current seed will be the incremented version of the value that was bit reversed. Conductors 64 therefore output the value that should be incremented by one to generate the next current seed if the output of bit-reversal circuit 60 is used as the PBRI reorder index.

FIG. 22 is a schematic representation of selection that is made to generate the PBRI reorder index. The circles containing “0” and “1” in the left column indicate the upper and lower portions of the circuit of FIG. 21. The “0” in the upper circle of FIG. 22 indicates the bit-reversed value of the current seed as incremented by zero. This is the value CANDID_PBRI_{—}0 in FIG. 21. The “1” in the lower circuit of FIG. 22 indicates the bit-reversed value of the current seed as incremented by one. This is the value CANDID_PBRI_{—}1 in FIG. 21. The box containing “0” in the right column indicates a selection circuit that determines whether the bit-reversed value from the “0” upper circle should be used as the PBRI reorder index or whether the bit-reversed value from the “1” lower circle should be used as the PBRI reorder index. The determination is to use the candidate reorder index CANDID_PBRI_{—}0 as the PBRI reorder index if VALID_TAG_{—}0 is true. If CANDID_PRBRI_{—}0 is used, then the value to be incremented to generate the next seed is selected to be CANDID_SEED_{—}0. If, however, the determination of the box containing “0” is not to use CANDID_PBRI_{—}0 due to VALID_TAG_{—}0 being false (CANDID_PBRI_{—}0 being out of range), then CANDID_PBRI_{—}1 is used as the PBRI reorder index. The value to be incremented to generate the next seed is selected to be CANDID_SEED_{—}1. The selection circuit of FIG. 22 outputs a multi-bit value WINNER INDEX that indicates which of the two bit-reversed values CANDID_PBRI_{—}0 and CANDID_PBRI_{—}1 was selected. In one example, the circuits of FIGS. 21 and 22 can be used sequentially for each step represented by FIGS. 9-18 by incrementing the seed value for each iterative use of the circuit of FIGS. 21 and 22.

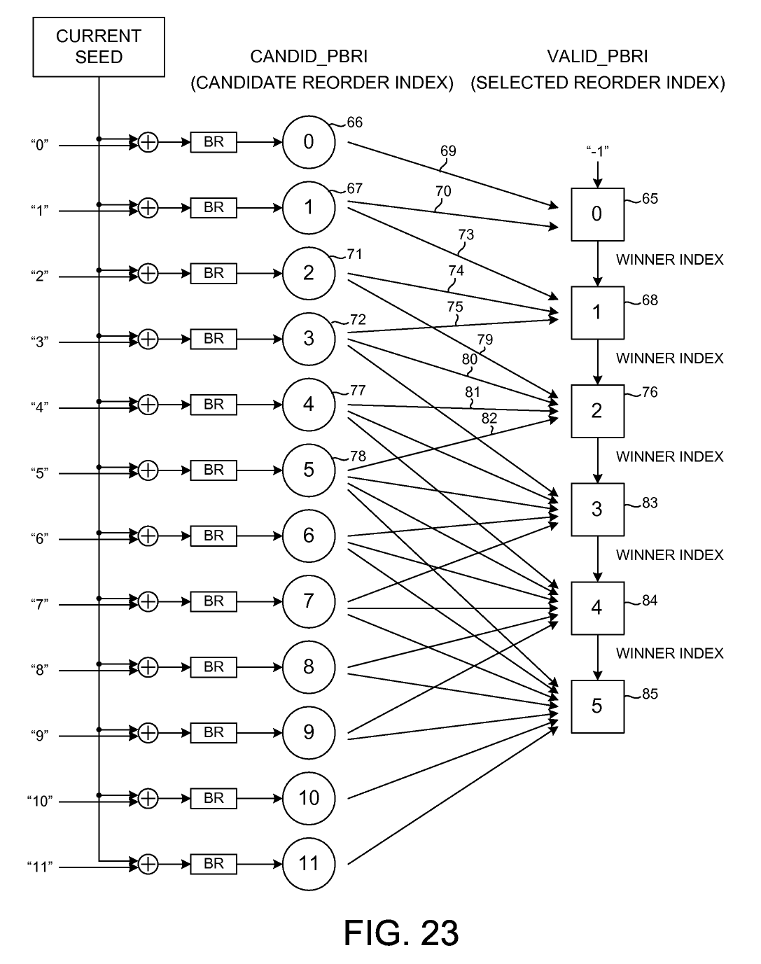

FIG. 23 illustrates a larger circuit which, for one input current seed value, simultaneously generates six PBRI reorder indices in parallel. The selection circuit 65 can select the CANDID_PBRI_{—}0 output 66, or selection circuit 65 can select the CANDID_PBRI_{—}1 output 67 if, due to an out of range problem, the CANDID_PBRI_{—}0 cannot be used. Note that two arrows 69 and 70 extend to selection circuit 65 to provide for these two possibilities. Selection circuit 68 is to receive the next two possible candidate PBRI values so that it can select the lower order candidate PBRI reorder index value unless that lower order value is out of range. Selection circuit 68 therefore receives the CANDID_PBRI_{—}1 output 67 as one value and CANDID_PBRI_{—}1 output 71 as the second value. If, however, selection circuit 65 selects the CANDID_PBRI_{—}1 output 67 as its PBRI reorder output value, then selection circuit 68, in order to receive the next two possible candidate PBRI values, must receive CANDID_PBRI_{—}2 output 71 and CANDID_PBRI_{—}3 output 72. Accordingly, note that there are three arrows 73, 74 and 75 extend to selection circuit 68 in order to provide for all possibilities.

Next, consider selection circuit 76. If neither of the first two candidate PBRI values selected by selection circuits 65 and 68 was out of range, then selection circuit 65 selected CANDID_PBRI_{—}0 output 66 and selection circuit 68 selected CANDID_PBRI_{—}1 output 67. The next candidate PBRI value would be CANDID_PBRI_{—}2 output 71. Under this circumstance, selection circuit may have to select CANDID_PBRI_{—}2 output 71 as its PBRI reoder index output value. This situation may be referred to as the “best case” in that the candidate PBRI value highest up in the diagram of FIG. 23 is selected. The “worst case” would occur if selection circuit 65 selected CANDID_PBRI_{—}1 (due to an out of range problem with CANDID_PBRI_{—}0), and if selection circuit 68 selected CANDID_PBRI_{—}3 (due to an out of range problem with CANDID_PBRI_{—}2). Under this worst case situation, selection circuit 76 would have to receive CANDID_PBRI_{—}4 output 77 and CANDID_PBRI_{—}5 output 78 in order to receive the next two possible candidate PBRI values. Accordingly, note that four arrows 79-82 extend to selection circuit 76 to provide for all possibilities.

This methodology of supplying candidate PBRI values to each successive selection circuit down the right column of selection circuits 65, 68, 76, 83-85 in FIG. 23 is continued to realize the interconnection illustrated in FIG. 23. Circuitry that performs the candidate PBRI value generation of the left side of FIG. 23 is realized as a first amount of non-sequential logic (also referred to as “combinatorial logic”) of the form illustrated in FIG. 21. Circuitry that performs the selection function of the right side of FIG. 23 is also realized as a second amount of non-sequential logic. Each selection circuit represented by a box in FIG. 23 receives a “WINNER INDEX” value from the selection circuit above. The circuit uses the incoming winner index to determine which two of the received CANDID_PBRI values should be processed using the out of range decision and selection operation of FIG. 22.

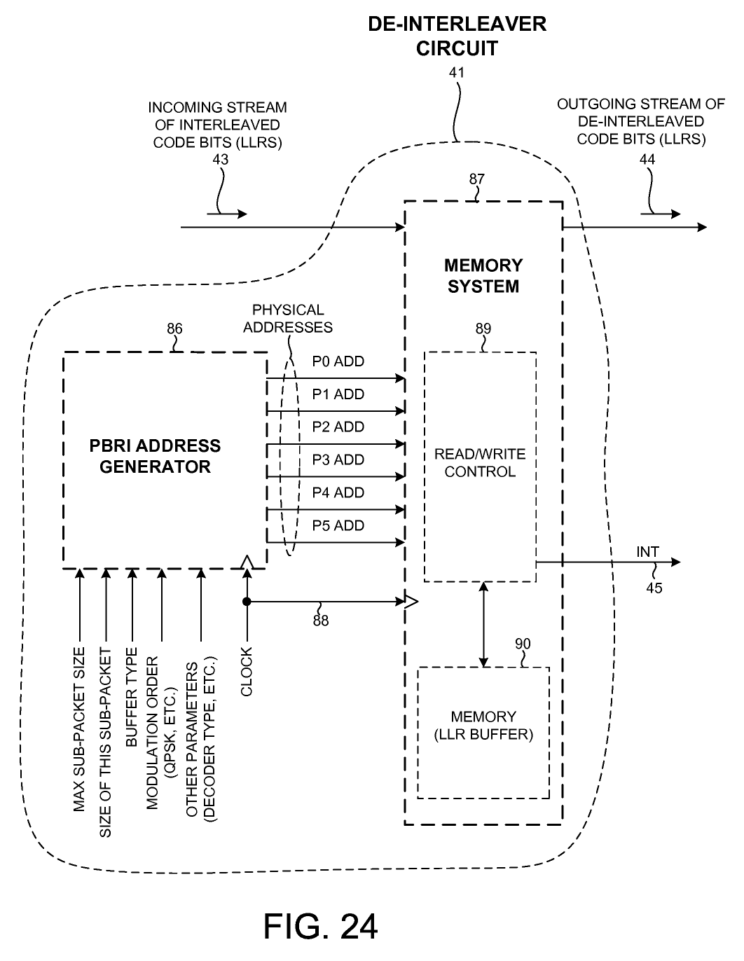

FIG. 24 is a block diagram of de-interleaver circuit 41 of FIG. 4. De-interleaver circuit 41 employs the non-sequential circuit of FIG. 23 to generate six PBRI reorder indices simultaneously and in parallel from one current seed. De-interleaver circuit 41 includes a PBRI address generator 86 and a memory system 87. Incoming code bits in the incoming stream 43 are received synchronized with respect to periods of the clock signal CLOCK on conductor 88. Depending on the modulation scheme employed, there may be a set of either two code bits received simultaneously in parallel each CLOCK cycle (if QPSK modulation is used), or a set of four code bits received simultaneously in parallel each CLOCK cycle (if 16-QAM modulation is used), or a set of six code bits received simultaneously in parallel each CLOCK cycle (if 64-QAM modulation is used). Each CLOCK cycle, starting with the receiving of the first code bit of a sub-packet, the PBRI address generator 86 generates six physical addresses P0-P5 associated with each set of simultaneously received code bits. The read/write control portion 89 of memory system 87 uses the appropriate number of these physical addresses P0-P5 for the modulation scheme employed to write the set of incoming code bits received during the CLOCK period into memory 90. The physical addresses P0-P5 are related, and generated from, the PBRI reorder indices described above. There may be code bits for multiple sub-packets stored at the same time in memory 90. The code bits for each sub-packet may, for example, be written into a different portion of memory 90. Within the appropriate portion of memory 90, however, the incoming code bits are written into de-interleaved memory locations as determined by the sequence of PBRI reorder indices.

If there are six code bits per set of code bits (64-QAM), then a set of six code bits received in a CLOCK cycle is written into memory 90 at physical addresses P0-P5. When the next set of six code bits is received, a separate set of six physical addresses is output by PBRI address generator 86 and the second set of six code bits is written simultaneously into memory 90. This process is repeated for each successive set of six code bits received. If, however, the modulation scheme is such that a set of simultaneously received code bits includes fewer than six code bits, then on each successive CLOCK cycle the smaller number of code bits is written into memory 90. If, for example, there are three code bits in each set of code bits, then during the first CLOCK cycle, the first set of three code bits is written into memory 90 at locations determined by physical addresses P0-P2 of the six physical addresses P0-P5 output by PBRI address generator 86. The last three physical addresses P3-P5 are, however, not used during this memory write. Then, during the next CLOCK cycle, the second set of three code bits is received. PBRI address generator 86 outputs a second set of six physical addresses, but the first three physical address values P0-P2 are the same as the last three physical addresses P3-P5 of the last CLOCK cycle. The second set of code bits is written into memory 90 at the next three physical addresses on P0-P2.

Once a complete sub-packet of code bits has been written into memory 90, and interrupt signal INT has been sent to processor 14, then processor 14 causes read/write control circuit 89 to reads the code bits out of memory 90 in linear order such that code bits form outgoing stream 44. In this example, code bits are written into memory 90 in reordered (de-interleaved) fashion, and are read out of memory 90 in linear fashion.

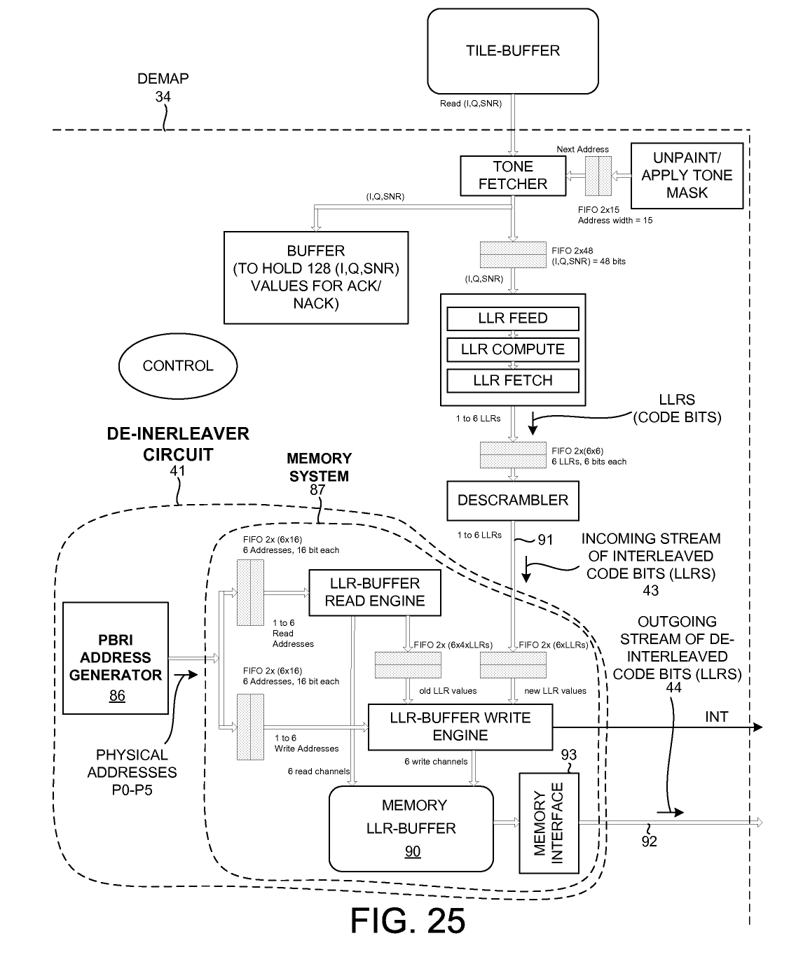

FIG. 25 is a more detailed diagram of de-interleaver circuit 41. The incoming stream 43 of code bits received via bus conductors 91. The outgoing stream 44 of code bits is output via bus conductors 92 and memory interface 93.

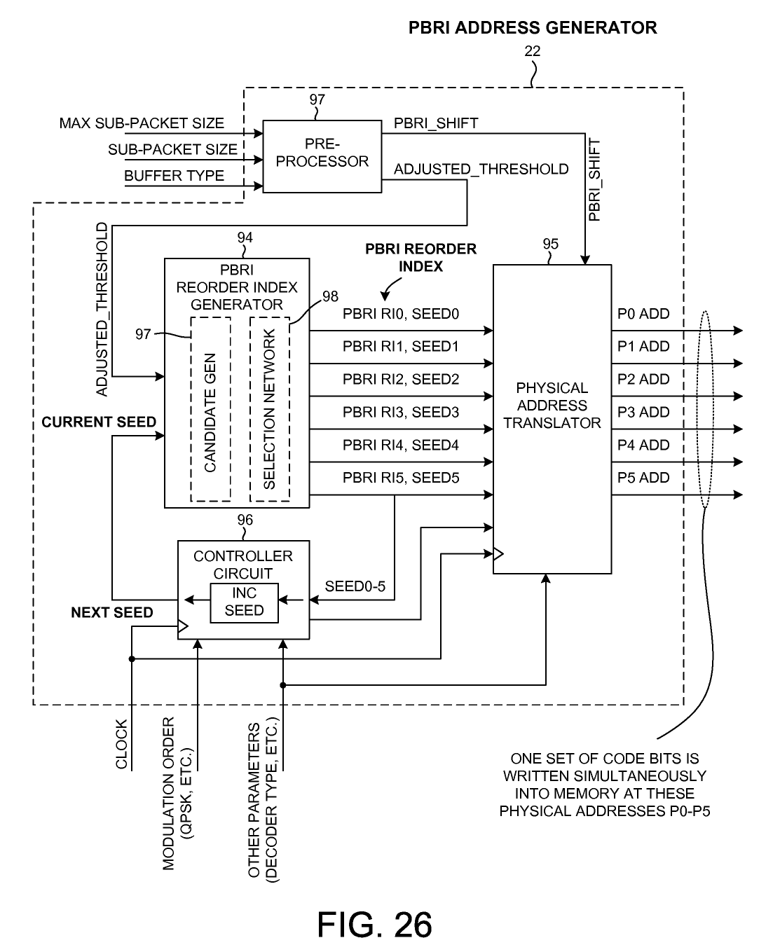

FIG. 26 is a more detailed block diagram of PBRI address generator 86. PBRI address generator 86 includes a PBRI reorder index generator 94, a physical address translator 95, a controller circuit 96, and a pre-processor circuit 97. Each of these portions may be realized by describing the function of the portion in a hardware description language such as Verilog or VHDL, and then supplying the hardware description language code to a commercially available hardware synthesizer that generates a description of an actual hardware circuit implementation.

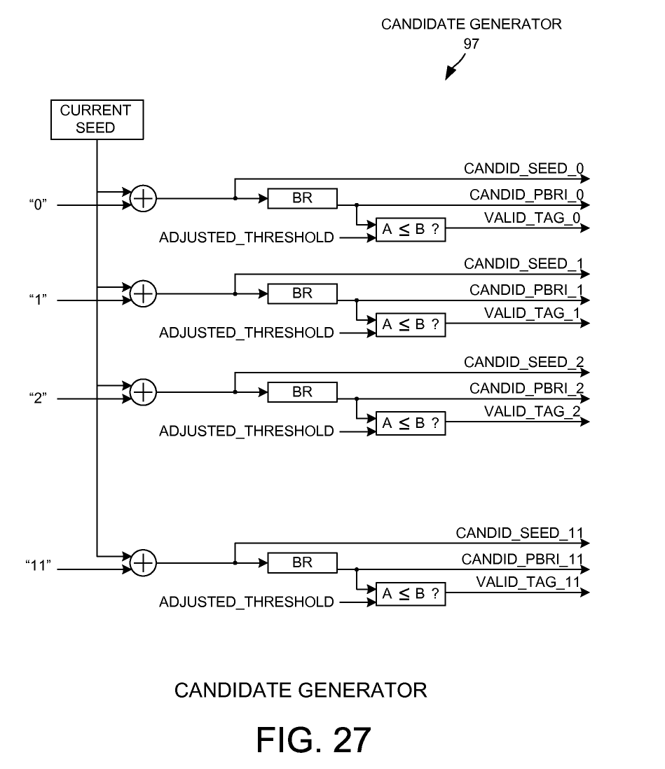

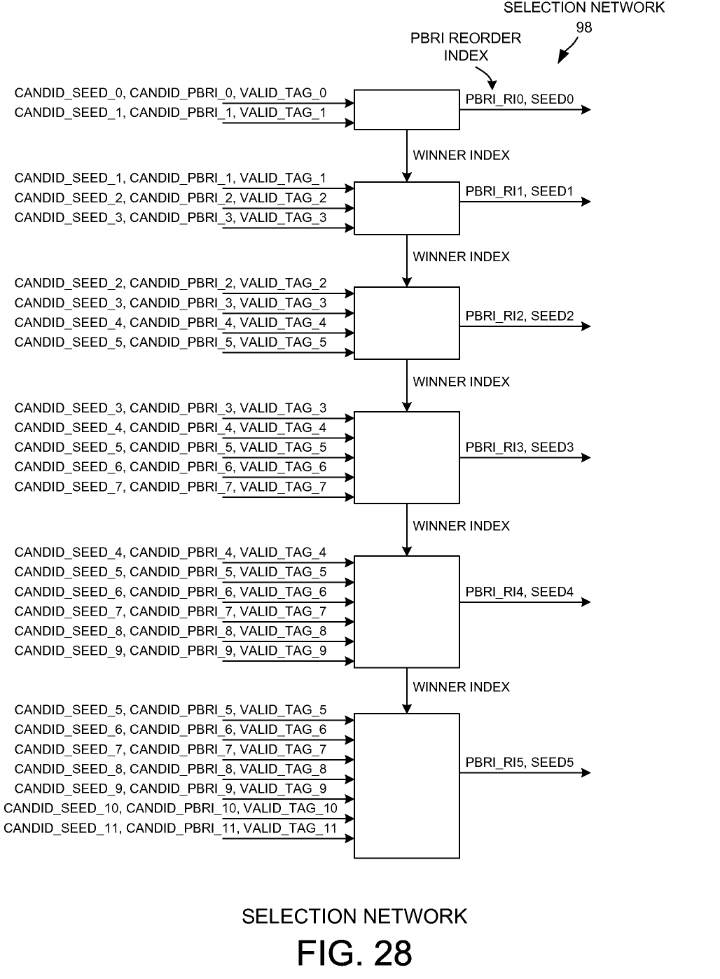

PBRI reorder index generator 94 includes an amount of non-sequential logic referred to here as the candidate generator circuit 97, and also includes an amount of non-sequential logic referred to here as the selection network 98. FIG. 27 is a more detailed block diagram of candidate generator circuit 97. The candidate generator 97 generates twelve candidate PBRI reorder indices from one current seed value. Candidate generator circuit 97 corresponds to the left side of FIG. 23. FIG. 28 is a more detailed block diagram of selection network 98. Selection network 98 corresponds to the right side of FIG. 23.

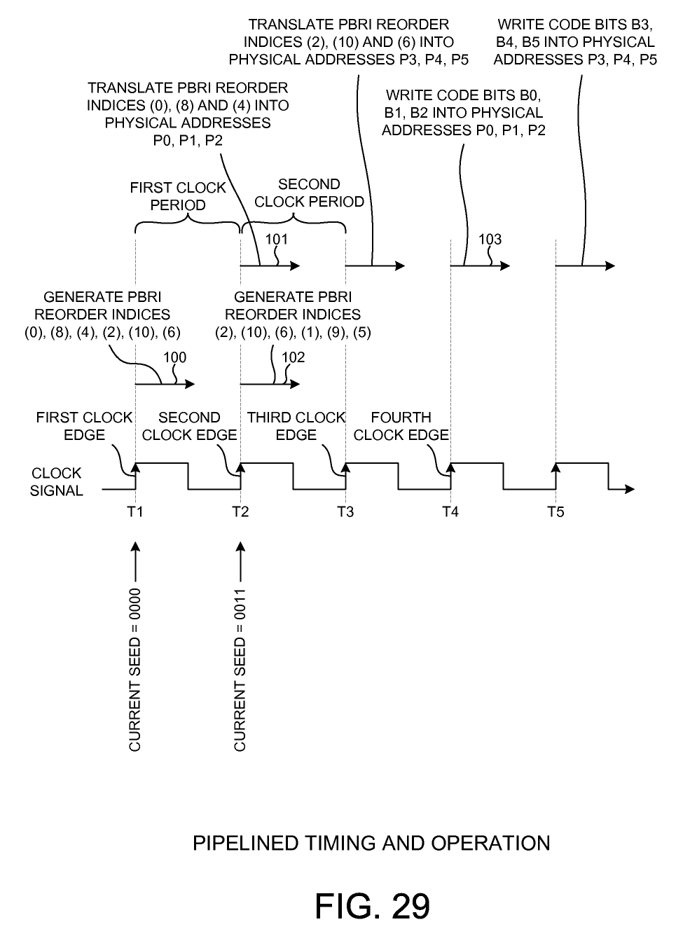

FIG. 29 illustrates an operational example. In this example, controller circuit 96 of FIG. 26 initially sets the current seed value to be “0000”. From current seed value “0000”, candidate generator 97 generates twelve candidate PBRI reorder indices, CANDID_PBRI_{—}0 through CANDID_PBRI_{—}11. With each candidate PBRI reorder index, the candidate generator 97 also outputs a VALID_TAG that indicates whether the associated candidate PBRI reorder index is out of range. With each candidate PBRI reorder index, the candidate generator 97 also outputs a candidate seed value (the next current seed value minus one) that will be used to generate the next seed in the event the associated candidate PBRI reorder index is the highest order PBRI reorder index selected by selection network 98. Selection network 98 selects PBRI reorder indices from the candidate PBRI reorder indices as explained above in connection with FIG. 23.

In this way, selection network 98 of FIG. 26 initially outputs PBRI reorder indices (0), (8), (4), (2), (10) and (6) (as PBRI_RI0 through PBRI_RI5) from current seed “0000”. As illustrated in FIG. 29, the first current seed “0000” is supplied to candidate generator 97 at time T1 on the first edge of the CLOCK signal. Candidate generator 97 and selection network 98 involve only non-sequential logic and the six PBRI reorder indices are generated simultaneous and in parallel bay the non-sequential logic. The arrow 100 indicates that the generation of these six PBRI reorder indices starts at the first edge of the CLOCK signal at time T1 and is complete before the next rising edge of the CLOCK signal at time T2. In this example, the incoming stream 43 of code bits involves sets of three code bits. After time T1, the SEED0 value is “0000”, the SEED1 value is “0001”, the SEED2 value is “0010”, the SEED3 value is “0011”, the SEED4 value is “0100”, and the SEED5 value is “0101”.

Next, in response to the second edge of the CLOCK signal at time T2, physical address translator 95 converts the six PBRI reorder indices into six corresponding physical addresses P0-P5. This physical address generation is indicated by arrow 101 in FIG. 29. The PBRI reorder indices coming into the physical address translator 95 are registered. Because three code bits are received by de-interleaver circuit 41 simultaneously as a set in the type of modulation employed in this example, controller circuit 96 selects the SEED2 value “0010”, increments this “0010” value to obtain the “current seed” value “0011” for the second PBRI reorder index generation cycle. Note the “CURRENT SEED=0011” notation in FIG. 29 at time T2. Candidate generator 97 receives this current seed value “0011” and in response candidate generator 97 and selection network 98 generate another set of six PBRI reorder indices. The first three lowest order PBRI reorder indices of this second CLOCK cycle are the same as the last three highest order PBRI reorder indices of the first CLOCK cycle. The second set of six PBRI reorder indices (2), (10), (6), (1), (9) and (5) is generated during the second CLOCK cycle as indicated by arrow 102 in FIG. 29. Note that the first three PBRI reorder indices of the second set (2), (10) and (6) at arrow 102 are the same as the last three PBRI reorder indices of the first set at arrow 100.

In the example of FIG. 29, starting at time T4 at the fourth rising edge of the CLOCK signal, the first set of three code bits B0, B1 and B2 is written into memory 90 at the physical addresses P0, P1 and P2. All three code bits are written simultaneously at the same time. This writing is identified in FIG. 29 by arrow 103. The pipelined operation of the de-interleaver circuit 41 of FIG. 24 continues in the fashion illustrated in FIG. 29. As indicated in FIG. 29, during the time that PBRI reorder index generator 94 is generating a next set of six PBRI reorder indices, the physical address translator 95 is generating a set of six physical addresses for the previously generated set of six PBRI reorder indices. On each successive use of PBRI reorder index generator 94 of FIG. 26, the controller circuit 96 increments the SEED output value corresponding to the last highest-order previously selected PBRI reorder index to generate the current seed for the next CLOCK cycle. Not only are the PBRI reorder index generation and physical address generation operations pipelined, but also the writing of code bits into memory 90 is pipelined. A previously received set of code bits is written into memory 90 at the same time that physical address translator 95 is generating a set of physical addresses for a later-received set of code bits, and at the same time that PBRI reorder index generator 94 is generating PBRI reorder indices for a still later-received set of code bits. Only some of the steps of the pipelined operation of de-interleaver circuit 41 of FIG. 24 are illustrated in FIG. 29 in order to emphasize and better illustrate the pipelining of de-interleaving steps for the first two sets of code bits.

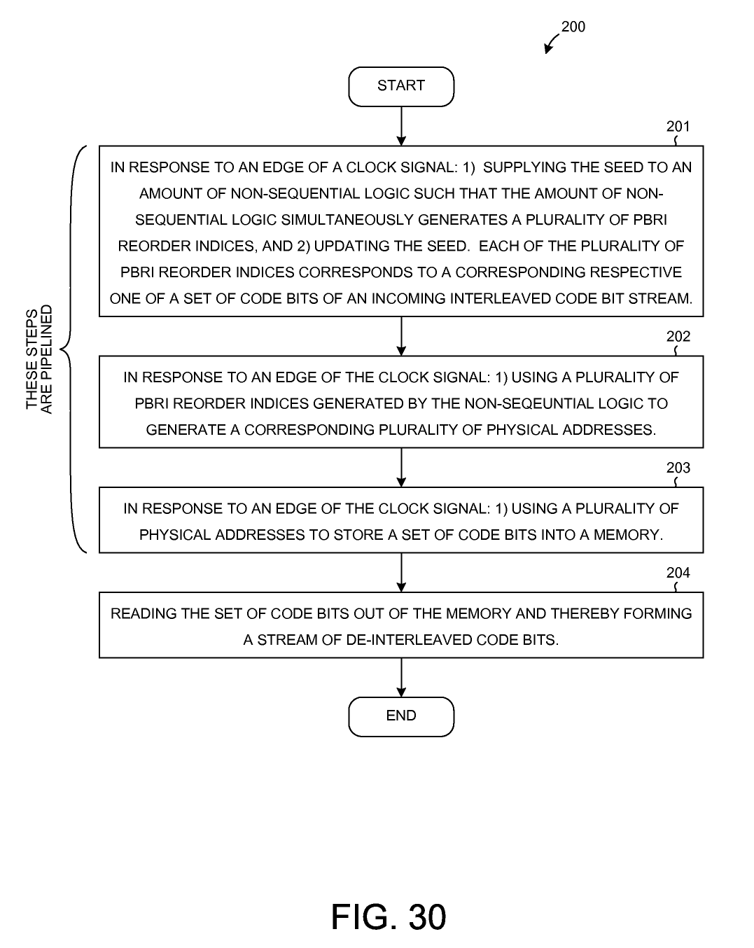

FIG. 30 is a flowchart of a novel method 200. In response to a rising edge of a clock signal, a seed is supplied (step 201 of FIG. 30) to an amount of non-sequential logic such that the amount of non-sequential logic simultaneously generates a plurality of PBRI reorder indices. Each of the plurality of PBRI reorder indices corresponds to a corresponding respective one of a set of code bits of an incoming interleaved code bit stream. In addition, the seed is updated for a subsequent use of the amount of non-sequential logic. In one example, another set of code bits is received into de-interleaver circuit 41 of FIG. 24 in response to each successive rising edge of the clock signal CLOCK and PBRI reorder index generator 94 of FIG. 26 simultaneously generates another plurality of PBRI reorder indices in response to each successive rising edge of the clock signal CLOCK. The seed is updated by controller circuit 96 of FIG. 26 by selecting an appropriate candidate seed as output by PBRI reorder index generator 94 and incrementing this selected candidate seed. The resulting incremented value is not supplied to PBRI reorder index generator 94 until the next rising edge of the clock signal CLOCK.

In response to each rising edge of the clock signal, a plurality of PBRI reorder indices generated by the non-sequential logic (in step 201) is used to generate (step 202 of FIG. 30) a corresponding plurality of physical addresses. In one example, a plurality of PBRI reorder indices output by PBRI reorder index generator 94 in FIG. 26 is used by physical address translator 95 in FIG. 26 to generate a corresponding plurality of physical addresses.

In response to each rising edge of the clock signal, a plurality of physical addresses (generated in step 202) is used to store (step 203 of FIG. 30) a set of code bits into a memory. In one example, memory system 87 of FIG. 24 uses a plurality of physical addresses received from PBRI address generator 86 to store a corresponding set of code bits into memory 90.

A set of code bits is then read (step 204 of FIG. 30) back out of the memory, thereby forming a stream of de-interleaved code bits. In one example, memory system 87 of FIG. 24 reads a set of code bits out of memory 90 and outputs the set of code bits to form outgoing de-interleaved stream 44.

PBRI Shift and Threshold Adjusting

The de-interleaving method described above can be practiced with all sub-packets being of the same sub-packet size. The de-interleaving method can also be practiced with size of incoming sub-packets being different, from sub-packet to sub-packet. According to the PBRI method described above, the number of bits in the seed and in the PBRI reorder indices is the minimum number of bits that can represent sub-packet size. In the example of FIGS. 6-8, for example, the sub-packet size was eleven. The PBRI reorder indices ranged from (0) to (10). The minimum number of bits that can represent eleven as a binary number is four bits. Note that the seeds and the PBRI reorder indices in FIGS. 6-8 are four bit values. If, however, sub-packet size changes from sub-packet received to sub-packet received, then complexities to the hardware are introduced.

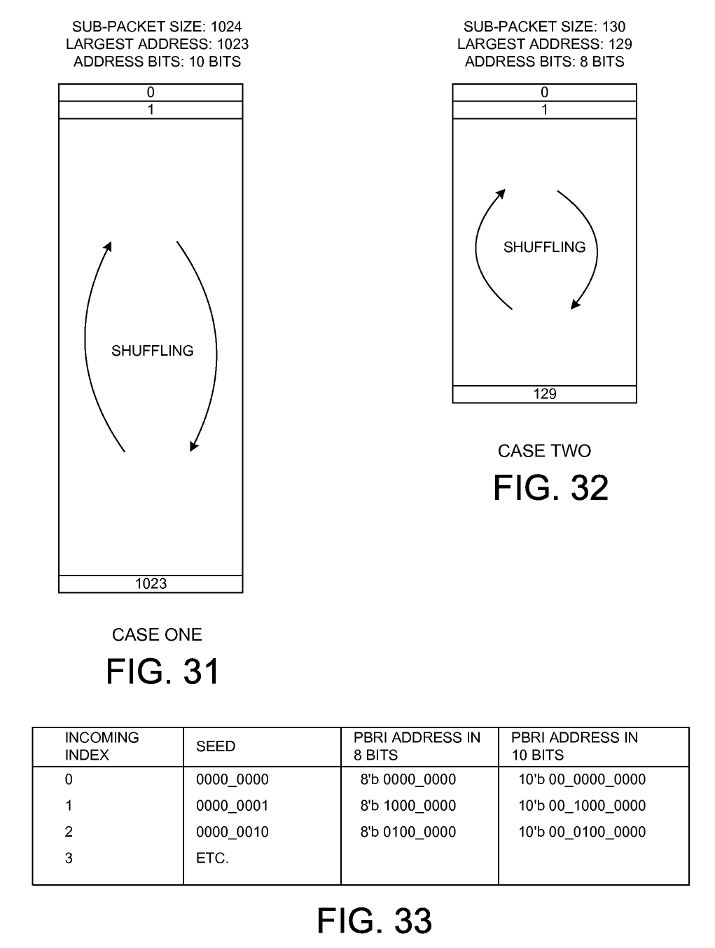

FIG. 31 is a diagram that illustrates an interleaving (shuffling) of code bit values for a sub-packet of size 1024. The number of bits in the seed values and in the PBRI reorder indices for the example of FIG. 31 is ten bits.

FIG. 32 is a diagram that illustrates an interleaving (shuffling) of code bit values for a sub-packet of size 130. The number of bits in the seed values and in the PBRI reorder indices for the example of FIG. 32 is eight bits.

For the de-interleaver circuit 41 to be able to handle sub-packets of both sizes, the de-interleaver hardware generates PBRI reorder indices that are wide enough to cover the maximum packet size case. Ten-bit PBRI reorder indices are therefore generated if sub-packets of the sizes illustrated in both FIG. 31 and in FIG. 32 are to be de-interleaved. FIG. 33 is a table that shows how PBRI reorder indices for the smaller sub-packet size of 130 looks when represented in the 10-bit address range. The table indicates that the bit-reverse operation for the case of FIG. 32 (sub-packet size 130) is not a straight forward bit-reversal operation. Instead, it is a bit-reversal operation that does not bit-reverse a certain number of “extra bits” in the leftmost bit positions. Note that the leftmost two bits in the rightmost column labeled “PBRI ADDRESS IN 10 BITS” are zeros, and that the remaining eight bits are the bit-reversed version of the corresponding 8-bit values in the “SEED” column.

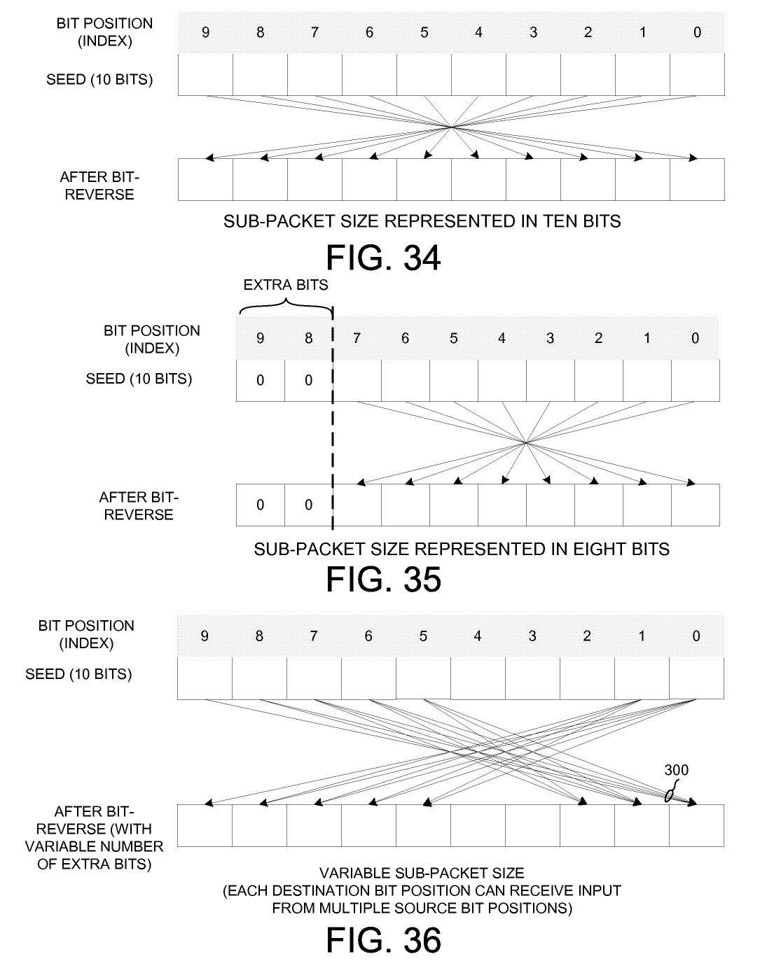

FIGS. 34 and 35 illustrate the two bit-reversal situations. FIG. 34 illustrates how all the bit positions are reversed in the first case (the case of FIG. 31) in which the sub-packet size is such that 10-bit seed and 10-bit PBRI reorder indices are used. FIG. 35 illustrates how bit positions (0) through (7) are reversed in the second case (the case of FIG. 32) in which the sub-packet size is 130. Note that there are two zeros in the leftmost two columns of FIG. 35, and that these values are not bit reversed. An arrow in FIGS. 34 and 35 indicates a bit-reversal.

In this example, for any sub-packet size anywhere from 32 to 1024, the bit-reversal hardware would be capable of implanting the left end of the bit-reversal value with a variable number of “extra bits”. The number of extra bits could be 0, 1, 2, 3, or 4. The “extra bits” are those bit positions that are not involved in the bit-reversal operation. The bit-reversal logic would be considerably more complicated than that of a simple fixed bit-reverse operation (where all sub-packets are of the same size). If the size of the sub-packet were between 33 and 64, then there would be four “extra bits”. If the size of the sub-packet were between 65 and 128, then there would be three “extra bits”. If the size of the sub-packet were between 129 and 256, then there would be two “extra bits”. If the size of the sub-packet were between 257 and 512, then there would be one “extra bit”. If the size of the sub-packet were between 513 and 1024, then there would be no “extra bits”.

FIG. 36 is a diagram that illustrates a further complexity of bit-reversal hardware that is capable of performing bit reversals on values having a variable number of bits. In FIG. 36, each arrow represents a bit reverse operation. Note that there are multiple arrows 300 extending into the rightmost bit position of the “after bit-reverse” value. These arrows indicate that the implementing hardware should be able to select the bit value from a selected one of many possible different bit positions of the seed (represented by the tails of the arrows), and should then assign this selected bit value to the rightmost bit position in the “after bit-reverse” value. Which bit value is selected depends on the sub-packet size and the number of “extra bits”. Note that such a multiplexing function is involved. A large and complex programmable multiplexing network would therefore likely be involved in implementing the variable sub-packet size bit-reverse operations illustrated in FIG. 36. (Not all the bit reverse arrows are illustrated in FIG. 36 because there are so many arrows and showing all the many arrows would unduly clutter the diagram).

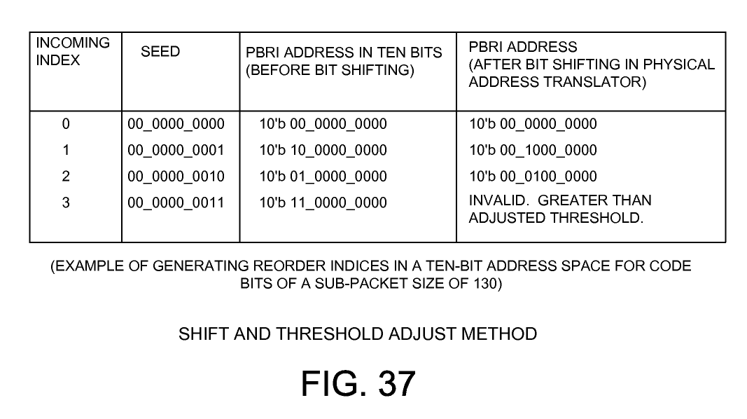

In another novel aspect, a variable sub-packet size bit reversal operation is performed without involving such an undesirably large programmable multiplexing network. FIG. 37 illustrates the novel method. In a first step, from the SUB-PACKET SIZE the minimum number of binary bits PS that can represent the sub-packet size (sub-packet size of the current sub-packet being processed) is determined. In one example, the SUB-PACKET SIZE information is received onto the de-interleaver circuit 41 before the first code bit of the sub-packet is received onto de-interleaver circuit 41. From the MAX SUB-PACKET SIZE, the number of bits MS that can represent the largest such sub-packet is determined. Then the difference between MS and the PS value is determined and is assigned to the value PBRI_SHIFT. The value MS is the bit-width of the hardware bit-reversers “BR” in the candidate generator 97 of FIG. 27. This PBRI_SHIFT value is the number of “extra bits” as described above. For example, in the case of FIG. 37 and FIG. 35, MS is ten bits, and PS is eight bits, and the difference value PBRI_SHIFT is two bits. This number of zeros is then appended to one end of each of the PS-bit seed values. Note that in FIG. 37, the leftmost two bits of each value in the SEED column are zeros. The SUB-PACKET SIZE value is also shifted two bits to the left to obtain the value ADJUSTED_THRESHOLD. These operations are performed in the pre-processor block 97 of FIG. 26.

In a second step, the resulting 10-bit seed value is bit-reversed, using a simple bit-reverse circuit such as illustrated in FIG. 34. In the example of FIG. 27, each box labeled “BR” includes one instance of such a simple bit-reverse circuit that is MS bits wide. The result of the bit-reverse operation is set forth in the column of FIG. 37 labeled “PBRI ADDRESS IN 10 BITS (BEFORE BIT SHIFTING)”. The “10′b” notation in FIG. 37 indicates the value is in 10-bit binary form. Note that the values in the “PBRI ADDRESS IN 10 BITS (BEFORE BIT SHIFTING)” column are the bit-reversed versions of the values in the “SEED” column.

In addition to the bit-reversals, the 10-bit bit-reversed values are compared to the ADJUSTED_THRESHOLD. This comparison occurs in the boxes labeled “A≦B?” in FIG. 27. The selection network 98 of FIG. 28 makes selections using the outputs of the candidate generator 97 as explained above. The resulting 10-bit PBRI reorder indices are output from the PBRI reorder index generator 94 of FIG. 26 to the physical address translator 95 of FIG. 26. (The 10-bit values output from selection network 98 of FIG. 28 are referred to as PBRI reorder indices even though they will, in this particular example, subsequently be shifted prior to physical address translation as explained below. The term “PBRI reorder index” applies to both the pre-shifted PBRI reorder index values as well as to the post-shift PBRI reorder index values).

In a third step, the PBRI recorder indices received onto physical address translator 95 of FIG. 26 are shifted the PBRI_SHIFT number of bit positions to the right, with zeros being shifted in from the left. Note that in FIG. 37, the values in the rightmost column labeled “PBRI ADDRESS AFTER BIT SHIFTING IN PHYSICAL ADDRESS TRANSLATOR” are the values that appear in the column to the left labeled “PBRI ADDRESS IN 10 BITS (BEFORE BIT SHIFTING)”, except that each such value is shifted two bit positions to the right, with zeros being shifted in from the left. This shifting is performed in the physical address translator 95 of FIG. 26, prior to the PBRI reorder index to physical address translation operation. Note that the 10-bit values in the rightmost column of FIG. 37 are the same as the desired values in the rightmost column of FIG. 33. The shift and threshold adjust method therefore generates the same result as performing the undesirable and complex programmable network bit-reverse operation described above in connection with FIG. 36.

In one advantageous aspect, the shift and threshold adjust method allows the hardware of the PBRI reorder index generator 94 of FIG. 26 not to be complicated with many slow programmable multiplexing networks. Rather, the shift and threshold adjust method allows the shifting hardware for handling sub-packets of different sizes to be provided in the physical address translator 95 of FIG. 26. Propagation delays through the non-sequential logic of the PBRI reorder index generator 94 may be a limiting factor that limits the clock rate of the CLOCK signal and limits the rate at which the overall de-interleaver circuit 41 can operate. Propagation delays through the physical address translator 95, on the other hand, may not limit the clock rate. Accordingly, by introducing the hardware complexities and delays associated with supporting different sub-packet sizes into the physical address translator 95 rather than into the time-critical PBRI reorder index generator 94, the throughput of de-interleaver circuit 41 is maximized.

The techniques described herein may be implemented by various means. For example, these techniques may be implemented in hardware, firmware, software, or a combination thereof. For a hardware implementation, the processing units used to perform the techniques at an entity (e.g., in a mobile communication device) may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electronic devices, other electronic units designed to perform the functions described herein, a computer, or a combination thereof. For a firmware and/or software implementation, the techniques may be implemented with code (e.g., programs, routines, procedures, modules, functions, instructions, etc.) that performs the functions described herein. In general, any computer/processor-readable medium tangibly embodying firmware and/or software code may be used in implementing the techniques described herein. For example, the firmware and/or software code may be stored in a memory (e.g., memory 16 of FIG. 3) and executed by a processor (e.g., processor 14 of FIG. 3). A software implementation may also involve a novel method described above being implemented in software stored on and executing in a personal computer. A memory that stores the firmware and/or software code may be implemented within the processor or may be external to the processor. The firmware and/or software code may also be stored in a computer/processor-readable medium such as Random Access Memory (RAM), Read-Only Memory (ROM), Non-Volatile Random Access Memory (NVRAM), Programmable Read-Only Memory (PROM), Electrically Erasable PROM (EEPROM), FLASH memory, floppy disk, Compact Disc (CD), Digital Versatile Disc (DVD), magnetic or optical data storage device, etc. The code may be executable by one or more computers/processors and may cause the computer/processor(s) to perform certain aspects of the functionality described herein.

Although certain specific embodiments are described above for instructional purposes, the teachings of this patent document have general applicability and are not limited to the specific embodiments described above. The use of a seed to generate a plurality of reorder indices in parallel using non-sequential logic, and the successive updating of the seed and corresponding successive generation of pluralities of reorder indices is not limited to a particular PBRI interleaving/de-interleaving scheme, but rather applies generally and broadly to other de-interleaving schemes. The novel hardware simplification techniques disclosed and the pipelining and of the reorder index generation process and the physical address translation process similarly apply generally and broadly to other de-interleaving schemes. The scope of PBRI address generation could be across a packet, or across a sub-packet, or across another logical group of code bits. The PBRI method described above can involve adding padding code bits to increase the size of a sub-packet before performing PBRI reorder index generation, or may not involve increasing the size of the group of code bits before performing PBRI reorder index generation. A plurality of PBRI reorder indices associated with a set of code bits may be generated simultaneously in parallel in the PBRI reorder index generator 94 of FIG. 26 and/or in the physical address translator 95 of FIG. 26. Accordingly, various modifications, adaptations, and combinations of the various features of the described specific embodiments can be practiced without departing from the scope of the claims that are set forth below.

What is claimed is:

1. An apparatus comprising:
a Pruned Bit-Reversal Interleaved (PBRI) address generator that simultaneously generates a plurality of PBRI reorder indices.

2. The apparatus of claim 1, further comprising:
a memory system that receives a plurality of physical addresses and uses the plurality of physical addresses to store code bits into a memory, wherein the PBRI address generator generates the plurality of physical addresses from the plurality of PBRI reorder indices.

3. The apparatus of claim 1, wherein the PBRI address generator includes:
a controller circuit that outputs a seed;
an amount of non-sequential logic that receives the seed and generates therefrom a plurality of candidate PBRI reorder indices; and
a selection network that receives the plurality of candidate PBRI reorder indices and outputs the plurality of PBRI reorder indices.

4. The apparatus of claim 1, wherein the PBRI address generator includes an amount of non-sequential logic and receives a clock signal, and wherein the plurality of PBRI reorder indices is generated by supplying a seed to the amount of non-sequential logic in response to a first edge of the clock signal such that the non-sequential logic generates the plurality of PBRI reorder indices from the seed within one period of the clock signal.

5. The apparatus of claim 4, wherein the amount of non-sequential logic includes a first amount of non-sequential logic that generates a plurality of candidate PBRI reorder indices and a second amount of non-sequential logic that selects certain of the candidate PBRI reorder indices and generates therefrom the PBRI reorder indices.

6. The apparatus of claim 4, wherein the PBRI reorder indices of the plurality of PBRI reorder indices correspond in a one-to-one relation to code bits of a plurality of code bits of an incoming stream of interleaved code bits received onto the apparatus.

7. The apparatus of claim 6, wherein the PBRI address generator further comprises:
a physical address translator that generates a plurality of physical addresses from the plurality of PBRI reorder indices in response to a second edge of the clock signal, wherein the second edge occurs at the end of the period of the clock signal.

8. The apparatus of claim 7, further comprising:
a memory system that receives the plurality physical addresses, wherein a plurality of code bits is stored into the memory system at locations determined by the plurality of physical addresses.

9. The apparatus of claim 1, further comprising:
a memory system, wherein each PBRI reorder index of the plurality of PBRI reorder indices determines where in the memory system a corresponding code bit will be stored in the memory.

10. The apparatus of claim 1, wherein the PBRI address generator is part of a radio receiver.

11. A method comprising:
(a) simultaneously generating a plurality of Pruned Bit-Reversal Interleaved (PBRI) reorder indices.

12. The method of claim 11, wherein the plurality of PBRI reorder indices is generated in (a) by supplying a seed to an amount of non-sequential logic in response to a first edge of a clock signal such that the non-sequential logic generates the plurality of PBRI reorder indices from the seed in parallel within one period of the clock signal.

13. The method of claim 12, further comprising:
(b) in response to a second edge of the clock signal using the plurality of PBRI reorder indices to generate a plurality of physical addresses, and wherein there is a one-to-one correspondence between the physical addresses of the plurality of physical addresses and the PBRI reorder indices of the plurality of PBRI reorder indices.

14. The method of claim 11, further comprising:
(b) using the plurality of PBRI reorder indices to store a corresponding plurality of code bits into a memory system, wherein there is a one-to-one relation between the plurality of PBRI reorder indices in (a) and the plurality of code bits stored in the memory system in (b).

15. The method of claim 11, further comprising:
(b) using each of the PBRI reorder indices generated in (a) to position a corresponding code bit within a de-interleaved output stream of code bits.

16. The method of claim 12, wherein the generating of (a) further involves updating the seed to generate an updated seed, and supplying the updated seed to the amount of non-sequential logic in response to a second edge of the clock signal such that the amount of non-sequential logic generates a second plurality of PBRI reorder indices from the updated seed within a second period of the clock signal.

17. The method of claim 11, wherein (a) occurs in a radio receiver.

18. A method, comprising:
(a) supplying a seed to a first amount of non-sequential logic such that the amount of non-sequential logic simultaneously generates therefrom a plurality of candidate reorder indices;
(b) selecting certain of the plurality of candidate reorder indices using a second amount of non-sequential logic and thereby generating a plurality of reorder indices; and
(c) using the plurality of reorder indices to order a plurality of code bits of an output stream of de-interleaved code bits.

19. The method of claim 18, further comprising:
(d) updating the seed and supplying the updated seed to the first amount of non-sequential logic such that a second plurality of candidate reorder indices is generated;
(e) selecting certain of the second plurality of candidate reorder indices using the second amount of non-sequential logic and thereby generating a second plurality of reorder indices; and
(f) using the second plurality of reorder indices to order a second plurality of code bits of the de-interleaved output stream of de-interleaved code bits.

20. The method of claim 19, wherein the seed of (a) is supplied in (a) in response to a first edge of a clock signal such that the plurality of candidate reorder indices is generated within a first period of the clock signal and such that the selecting of (b) occurs during the first period of the clock signal, wherein the updated seed of (d) is supplied in (d) in response to a second edge of the clock signal such that the generating of the second plurality of candidate reorder indices of (d) and the selecting of the second plurality of candidate reorder indices of (e) occur in a second period of the clock signal that immediately follows the first period of the clock signal.

21. The method of claim 18, wherein (a), (b) and (c) are performed in a radio receiver.

22. An apparatus, comprising:
means for receiving a seed and for simultaneously generating from the seed a plurality of reorder indices; and
a control circuit that updates the seed.

23. The apparatus of claim 22, wherein the means for receiving is also for using the plurality of reorder indices to de-interleave a plurality of code bits.

24. The apparatus of claim 22, wherein the means simultaneously generates a plurality of candidate reorder indices from the seed, and wherein the means selects certain of the plurality of candidate reorder indices to generate the plurality of reorder indices.

25. The apparatus of claim 22, wherein the means and the control circuit are parts of a radio receiver.

26. An apparatus in a wireless communication system, comprising:
a memory system operative to store code bits of an input stream of interleaved code bits and to provide an output stream of de-interleaved code bits; and
an address generator operative to generate addresses supplied to the memory system such that the input stream of interleaved code bits is de-interleaved in accordance with a pruned bit-reversal interleaved scheme, and such that the address generator simultaneously generates a plurality of addresses for de-interleaving all the code bits of a set of code bits in the input stream.

27. A computer program product, comprising:
computer-readable medium comprising:
code for causing a computer to use a seed to generate a plurality of Pruned Bit-Reversal Interleaved (PBRI) reorder indices.

28. The computer program product of claim 27, wherein the computer includes a processor, a memory, and a de-interleaver operatively coupled to the processor, and wherein the memory is the computer-readable medium and stores the code.

29. The computer program product of claim 27, wherein the computer-readable medium further comprises:
code for causing the computer to translate the plurality of PBRI reorder indices into a corresponding plurality of physical addresses.

30. The computer program product of claim 27, wherein the plurality of PBRI reorder indices are simultaneously generated from the seed.

31. The computer program product of claim 30, wherein the computer-readable medium further comprises:
code for causing the computer to update the seed and to generate from the updated seed a second plurality of PBRI reorder indices, wherein the second plurality of PBRI reorder indices are generated simultaneously from the updated seed.
